(19) United States
(12) Patent Application Publication
(10) Pub. No.: US 2021/0097700 A1
(43) Pub. Date: Apr. 1, 2021

(54) DETERMINING MOVEMENT OF A SUBSTRATE

(71) Applicant: Hewlett-Packard Development Company, L.P., Spring, TX (US)

(72) Inventors: Li Qian, Sant Cugat del Valles (ES); Juan Carlos Arco Fernandez, Sant Cugat del Valles (ES)

(21) Appl. No.: 16/977,955

(22) PCT Filed: Mar. 27, 2018
(86) PCT No.: PCT/US2018/024482

§ 371 Date: Sep. 3, 2020

(51) Int. Cl. G06T 7/285; G06T 7/246; B41J 11/00

(52) U.S. Cl. CPC G06T 7/285; G06T 7/248; G06T 7/001; G06T 2207/10016; G06T 2207/30176; B41J 11/0095

(57) ABSTRACT

An example system is disclosed for measuring movement of print media, the system comprising first image capture apparatus to capture a first image of a portion of print media, and second image capture apparatus to capture second images of the portion of print media using an image capture parameter based on the first image and to measure movement of the print media using the second images.

### BACKGROUND

A printing device may transport a substrate such as print media. It can be useful to measure movement of the substrate accurately so that transport of the substrate, or application of print agent onto the substrate, can be controlled in view of the measured movement.

### BRIEF DESCRIPTION OF DRAWINGS

Examples will now be described, by way of non-limiting example, with reference to the accompanying drawings, in which:

FIG. 1 is a simplified schematic of an example of a system for measuring movement of print media;

FIG. 2 is a simplified schematic of an example of a system for measuring movement of print media;

FIG. 3 is a simplified schematic of an example of apparatus for determining movement of a substrate;

FIG. 4 is a flow chart of an example of a method of determining movement of a substrate; and

FIG. 5 is a flow chart of an example of a method of determining movement of a substrate.

### DETAILED DESCRIPTION

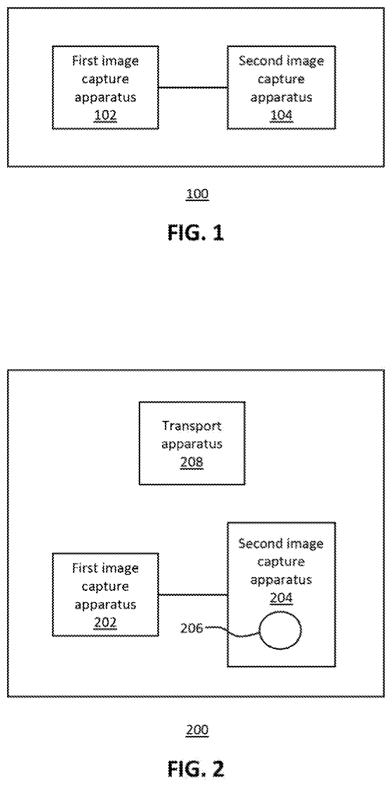

FIG. 1 is a simplified schematic of an example of a system 100, such as for example a system for measuring movement of print media. The system 100 comprises first image capture apparatus 102 to capture a first image of a portion of print media. The first image capture apparatus 102 may be, for example, a digital image capturing device such as a digital camera, charge Coupled Device (CCD) or any apparatus capable of capturing a digital image of the portion of print media.

The system 100 also includes second image capture apparatus 104 to capture second images of the portion of print media using an image capture parameter based on the first image and to measure movement of the print media using the second images. In some examples, the second image capture apparatus 104 is downstream of the first image capture apparatus 102. That is, for example, as the print media is transported past or through the system 100, the first image capture apparatus 102 captures the first image of the portion of print media, and subsequently the second image capture apparatus 104 captures the second images of the portion of print media. In some examples, the portion of print media may first be closer to the first image capture apparatus 102, and subsequently be closer to the second image capture apparatus 104. In some examples, the speed or approximate speed of the substrate may be used to determine when the second image capture apparatus can capture the second images after the first image capture apparatus 102 has captured the first image.

In some examples, the image capture parameter may be based on a property related to the appearance of the first image, and thus the appearance of the portion of print media. For example, the portion of print media may include marks such as print agent, watermarks, marks provided by a manufacturer of the print media or other marks. These marks may have a different brightness, contrast, reflectivity, reflectance, luminance and intensity than the remainder of the print media. Therefore, depending on the location of the portion of print media captured in the first and second images, the brightness for example of the portion could vary. In order for the second image capture apparatus 104 to capture the second images effectively, and/or to avoid artefacts in the second images such as for example clipping, saturation or low contrast, the second images are captured using an image capture parameter based on the first image. For example, an illumination of the portion of the print media when the second images are being captured may be based on the first image, and/or an exposure (e.g. shutter speed and/or aperture) of the second image capture apparatus 104 may be adjusted based on the first image. Thus, for example, the first image may provide an indication of the brightness, contrast, reflectivity, reflectance, luminance, intensity or other parameter of the portion of print media. This can be used, for example, to ensure that the second images include sufficient detail such that movement of the substrate can be determined from the second images. In some examples, the pixel offset value of the second images captured by the second image capture apparatus 104 may be controlled based on the first image. For example, the centre value of one or more pixels in the second images (e.g. the average intensity value) may be controlled to be at or around the centre of the dynamic range of the pixel intensity values in the second images. In some examples, the pixel gain value for the second image capture apparatus 104 may be controlled based on the first image. As a result, in some examples, the dynamic range of the pixel intensity values in the second images may use the full available range or a substantial portion of the available range.

In some examples, movement of the print media relative to the second image capture apparatus may be determined by comparing the second images, for example to find common features between the second images. For example, correlation between two images may indicate if there has been any movement of the print media, and the amount of the movement. The movement can be used to control, for example, transport of the print media (e.g. transport that causes the movement of the print media), and/or application of print agent to the print media. In some examples, even if the print media or the portion of the print media appears blank, minor texture details may still be detected in the second images and used to measure correlation between the second images, and hence determine the movement.

FIG. 2 is a simplified schematic of an example of a system 200, such as for example a system for measuring movement of print media. The comprises first image capture apparatus 202 to capture a first image of a portion of print media, and second image capture apparatus 204 to capture second images of the portion of print media using an image capture parameter based on the first image and to measure movement of the print media using the second images. In some examples, the first image capture apparatus 202 and the second image capture apparatus 204 are similar in at least some aspects to the first image capture apparatus 102 and second image capture apparatus 104 respectively.

The second image capture apparatus 204 comprises an lumination device 206. The image capture parameter thus comprises a brightness of the illumination device. Therefore, for example, the brightness of the illumination device when capturing the second images is at a level that allows sufficient detail to be captured in the second images. For example, print media may be generally white with dark markings. If the portion of the print media is an area that does not include dark markings or includes a small proportion of dark markings, the illumination can be controlled to be relatively low. If, on the other hand, the portion of the print media includes a substantial amount of dark markings, as indicated by the first image, the illumination can be controlled to be relatively bright. In some examples, a medium amount of dark markings in the portion can result in a medium brightness for the illumination. The illumination may be provided in some examples by an array of light sources, such as Light Emitting Diodes (LEDs), and the brightness level is controlled by illuminating different numbers of light sources. In some examples, illumination may be provided by one or more light sources, such as LEDs, and the brightness level of each light source may be controlled, for example by controlling the current, voltage and/or duty cycle provided to the light source.

In some examples, the image capture parameter comprises an exposure and/or an illumination of the portion of print media by the second image capture apparatus. Each of these may for example be controlled based on the first image. For example, if the first image is relatively dark (e.g. includes a substantial amount of dark markings), the exposure may be increased (for example, a shutter speed and/or aperture size may be increased), and if the image is relatively light, the exposure may be decreased. The illumination may also or alternatively be increased or decreased respectively.

In some examples, the second image capture apparatus is to capture the second images using an image capture parameter based on a property of the first image, wherein the property is based on one of a brightness, contrast, reflectivity, reflectance, luminance and intensity of the first image. This may in some examples reflect the brightness, contrast, reflectivity, reflectance, luminance and intensity of the first image. Therefore, for example, if the first image displays high brightness, the image capture parameter may be controlled accordingly to account for the bright portion of the print media that is expected to be captured as second images by the second image capture apparatus 204.

In some examples, the second image capture apparatus is to capture second images of the portion of print media using an image capture parameter based on an average of the property over the first image. For example, the image capture parameter may be based on an average of a pixel intensity of the pixels in the first image. A higher average may for example indicate that the portion of the print media is relatively bright. Alternatively, another function of the pixels of the first image may be used to determine the image capture parameter.

The system 200 also includes transport apparatus 208 to transport the print media. In some examples, the transport apparatus causes the movement of the substrate that is measured by the system 200. The transport apparatus 208 may comprise, for example, one or more rollers or conveyors.

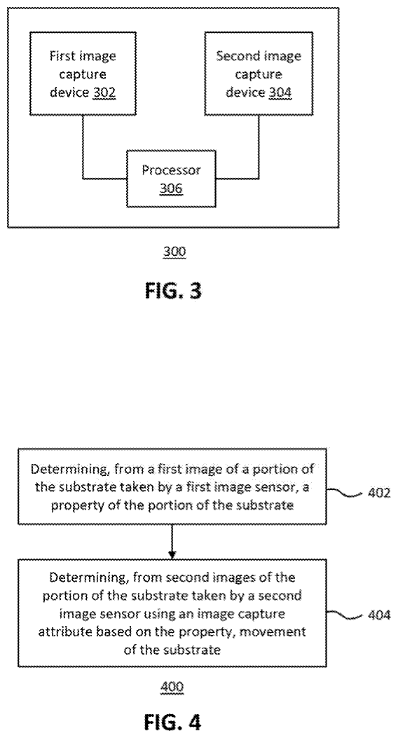

FIG. 3 is a simplified schematic of an example of apparatus 300, for example apparatus for determining movement of a substrate. The apparatus comprises a first image capture device 302 to provide an image of a part of a substrate, and a second image capture device 304. The apparatus 300 also includes a processor 306 to receive the image (e.g. from the first image capture device 302) and to adjust a characteristic of the second image capture device 304 based on a property of the image.

The processor 306 is to receive further images of the part of the substrate from the second image capture device 304 based on the characteristic and to determine movement of the substrate based on the further images. For example, the processor may adjust an exposure and/or illumination of the part of the substrate by the second image capture device 304 based on the characteristic. The further images received from the second image capture device 304 by the processor 306 may therefore show sufficient detail to enable movement of the substrate to be determined therefrom, even if the part of the substrate is for example light, dark, a mixture of light and dark portions, or an intermediate brightness level.

In some examples, the characteristic comprises of one of a brightness, contrast, reflectivity, reflectance, luminance and intensity of the first image and/or the part of the substrate.

In some examples, the processor 306 is also to determine the movement of the substrate by comparing the further images. For example, the further processor 306 may measure or determine movement of one or more common features in the further images captured by the second image capture device 304 at different times, and determine movement therefrom. The time between the images and the amount of movement of the one or more common features may indicate for example a speed of movement of the substrate. In some examples, movement of the substrate may be determined or measured by determining or measuring correlation between the further images from the second image capture device 304.

FIG. 4 is a flow chart of an example of a method 400 of determining movement of a substrate. The method 400 comprises, in a first block 402, determining, from a first image of a portion of the substrate taken by a first image sensor, a property of the portion of the substrate. The property may be for example one or more of a brightness, contrast, reflectivity, reflectance, luminance and intensity of the portion of the substrate. This may be determined from the first image, for example by determining an average or other function of the pixel intensity across the first image, determining an intensity range over the first image, or any other characteristic of the first image.

The method 400 also includes, in block 404, determining, from second images of the portion of the substrate taken by a second image sensor using an image capture attribute based on the property, movement of the substrate. The image capture attribute may be for example an exposure and/or illumination of the portion of the substrate by the second image sensor. In some examples, therefore, the second images may include sufficient detail for the movement of the substrate to be determined, and the image capture parameter may be adjusted to reduce or eliminate issues related to varying brightness or reflectance (for example) across the substrate, such as saturation or low contrast for example. The second images may for example be taken at different times.

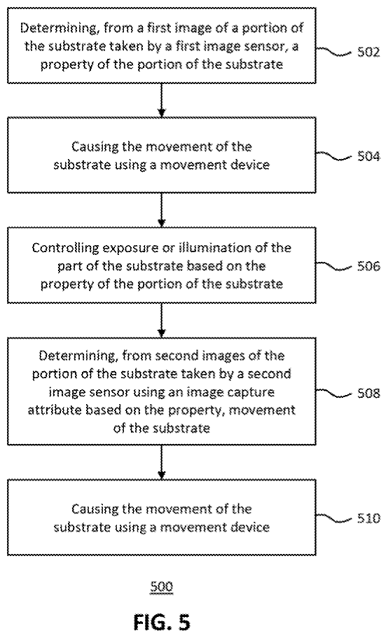

FIG. 5 is a flow chart of an example of a method 500 of determining movement of a substrate. The method 500 comprises, in a first block 502, determining, from a first image of a portion of the substrate taken by a first image sensor, a property of the portion of the substrate. The property may be for example one or more of a brightness, contrast, reflectivity, reflectance, luminance and intensity of the portion of the substrate. This may be determined from the first image, for example by determining an average or other function of the pixel intensity across the first image, determining an intensity range over the first image, or any other characteristic of the first image.

The method 500 also includes, in block 504, causing the movement of the substrate using a movement device. The movement device may be for example one or more rollers and/or conveyors.

In block 506, the method 500 includes controlling exposure and/or illumination of the part of the substrate based on the property of the portion of the substrate. For example, exposure and/or illumination may be increased where the property of the portion of the substrate indicates that the portion of the substrate is relatively dark or includes dark markings, and conversely the exposure and/or illumination may be decreased for brighter portions of the substrate.

The method 500 also includes, in block 508, determining, from second images of the portion of the substrate taken by a second image sensor using an image capture attribute based on the property, movement of the substrate. The movement may be determined for example by tracking movement of features between the second images, which may for example be captured at different times. In some examples, correlation between the second images is determined to determine the substrate movement.

Block 510 of the method 500 includes controlling the movement device based on the determined movement. For example, the determined movement may be used in a feedback mechanism to control the movement device such that the movement device moves the substrate in an intended manner, such as for example at an intended speed or by an intended amount.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A system for measuring movement of print media, the system comprising:
first image capture apparatus to capture a first image of a portion of print media; and
second image capture apparatus to capture second images of the portion of print media using an image capture parameter based on the first image and to measure movement of the print media using the second images.

2. The system of claim 1, wherein the image capture parameter comprises one of an exposure and an illumination of the portion of print media by the second image capture apparatus.

3. The system of claim 1, wherein the second image capture apparatus comprises an illumination device, and wherein the image capture parameter comprises a brightness of the illumination device.

4. The system of claim 1, wherein the second image capture apparatus is to capture the second images using an image capture parameter based on a property of the first image, wherein the property is based on one of a brightness, contrast, reflectivity, reflectance, luminance and intensity of the first image.

5. The system of claim 1, wherein the second image capture apparatus is to capture second images of the portion of print media using an image capture parameter based on an average of the property over the first image.

6. The system of claim 1, wherein the second image capture apparatus is to measure movement of the print media based on correlation between the second images.

7. The system of claim 1, comprising transport apparatus to transport the print media.

8. Apparatus for determining movement of a substrate, the apparatus comprising:
a first image capture device to provide an image of a part of a substrate;
a second image capture device; and
a processor to receive the image and to adjust a characteristic of the second image capture device based on a property of the image;
wherein the processor is to receive further images of the part of the substrate from the second image capture device based on the characteristic and to determine movement of the substrate based on the further images.

9. The apparatus of claim 8, wherein the processor is to adjust the characteristic of the second image capture device by controlling exposure or illumination of the part of the substrate based on the property of the image.

10. The apparatus of claim 8, wherein the characteristic comprises of one of a brightness, contrast, reflectivity, reflectance, luminance and tensity of the first image.

11. The apparatus of claim 8, wherein the process is to determine the movement of the substrate by comparing the further images.

12. A method of determining movement of a substrate, the method comprising:
determining, from a first image of a portion of the substrate taken by a first image sensor, a property of the portion of the substrate;
determining, from second images of the portion of the substrate taken by a second image sensor using an image capture attribute based on the property, movement of the substrate.

13. The method of claim 12, comprising controlling exposure or illumination of the part of the substrate based on the property of the portion of the substrate.

14. The method of claim 12, comprising causing the movement of the substrate using a movement device.

15. The method of claim 14, comprising controlling the movement device based on the determined movement.
